(19) United States
(12) Patent Application Publication
(10) Pub. No.: US 2011/0073251 A1
(43) Pub. Date: Mar. 31, 2011

(54) COMPONENT BONDING PREPARATION METHOD

(75) Inventors: John H. Vontell, Manchester, CT (US); Stephen L. Kaplan, San Carlos, CA (US)

(73) Assignee: UNITED TECHNOLOGIES CORPORATION, Hartford, CT (US)

(21) Appl. No.: 12/569,329

(22) Filed: Sep. 29, 2009

(51) Int. Cl. H05H 1/00; B32B 38/00

(52) U.S. Cl. 156/272.6; 204/157.74

(57) ABSTRACT

A component bonding preparation method employs plasma to prepare a component for bonding. A first plasma is used to hydroxylate a component surface. A second plasma is used to silanize the component surface.

### CROSS-REFERENCE TO RELATED APPLICATION(S)

This is a related application to U.S. patent application Ser. No. 12/255,203, filed on Oct. 21, 2008 and U.S. patent application Ser. No. 12/255,177, filed on Oct. 21, 2008.

### STATEMENT OF GOVERNMENT INTEREST

The U.S. Government has a paid-up license in this invention and the right in limited circumstances to require the patent owner to license others on reasonable terms as provided for by the terms of Contract No. N00019-02-C-3003 awarded by the United States Navy.

### BACKGROUND

The present invention relates to a method of component bonding preparation. More particularly, the present invention relates to a method of component bonding preparation where pre-bonding preparations are performed using plasmas.

A typical process for preparing a component surface for bonding may include several steps. First, the component surface may be abraded with water and grit or sanded by hand. Abrading and sanding a delicate component, such as a fan inlet shroud fairing, can result in damage to the component. Components may also have geometries that are not conducive to hand sanding. An example of such a component is a fan inlet shroud fairing having a U-shaped bend at a leading edge and two trailing edges that extend from the bend. The trailing edges are rigid, yet fragile and may be separated by less than one inch (2.54 cm). The trailing edges may also contain fragile embedded electrical components. Hand sanding the interior surfaces of the trailing edges is extremely difficult to perform due to the geometry involved and presents a high risk of damage to fragile elements. Abrading and sanding by hand are also labor intensive processes. Second, once abraded, the component surface may be rinsed with water to remove debris from the abrading or sanding and dried. The water used for rinsing must be removed before continuing the bonding preparation. Removal is typically performed by placing the component in an oven for several hours or even up to one full day. Once dried, the component then needs to cool to room temperature. These drying and cooling steps take a significant amount of time. Third, a solvent may be applied to the component surface to further clean the surface, followed by a silane primer. The silane primer is typically applied by wiping or brushing the silane primer onto the component surface. Again, some components, such as fan inlet shroud fairings, have geometries that are not conducive to the application of a silane primer by a brush or cloth. Once the silane primer has been applied, the primed component is cured for a time in humidity conditions greater than fifty percent humidity. The component surface may be bonded following the curing of the primed component. Due to the instability of the silane primer when wiped or brushed onto the component surface, bonding typically must take place within eight hours of curing.

Due to the difficulties that unique geometries and fragile components present to the typical bonding preparation process, an improved process for bonding preparation is desired. Additionally, a process that extends the shelf life of the applied primer past eight hours is also desired.

### SUMMARY

In a method according to the present invention, a component is placed inside a processing vessel. A surface of the component is hydroxylated with a plasma by introducing a hydroxylating agent into the processing vessel and applying electromagnetic radiation to excite the hydroxylating agent into a first plasma, which adds hydroxyl groups to the component surface. The component surface is silanized with a plasma by introducing a silane into the processing vessel and applying electromagnetic radiation to excite the silane into a second plasma, which is hydrolyzed by the hydroxyl groups on the component surface to bond a silane layer to the component surface.

In a component bonding method, the method includes cleaning a component surface, plasma hydroxylating the component surface, plasma silanizing the component surface and bonding the plasma silanized component surface to a substrate.

### BRIEF DESCRIPTION OF THE DRAWINGS

FIG. 1 is a view showing the arrangement of a plasma processing apparatus.

FIG. 2 is a schematic illustration of one embodiment of a component bonding preparation method using plasma.

FIG. 3 is a schematic illustration of an additional embodiment of a component bonding preparation method using plasma.

FIG. 4 is a bar graph illustrating relative bond strengths of bonds prepared with conventional silanes and plasma silanes.

### DETAILED DESCRIPTION

Plasma processing has been used for a variety of purposes. Plasmas have previously been used to clean articles and prepare surfaces for bonding. The present invention further advances plasma capabilities by providing a method of silanizing component surfaces using plasma and extending the stability and shelf life of silanized component surfaces.

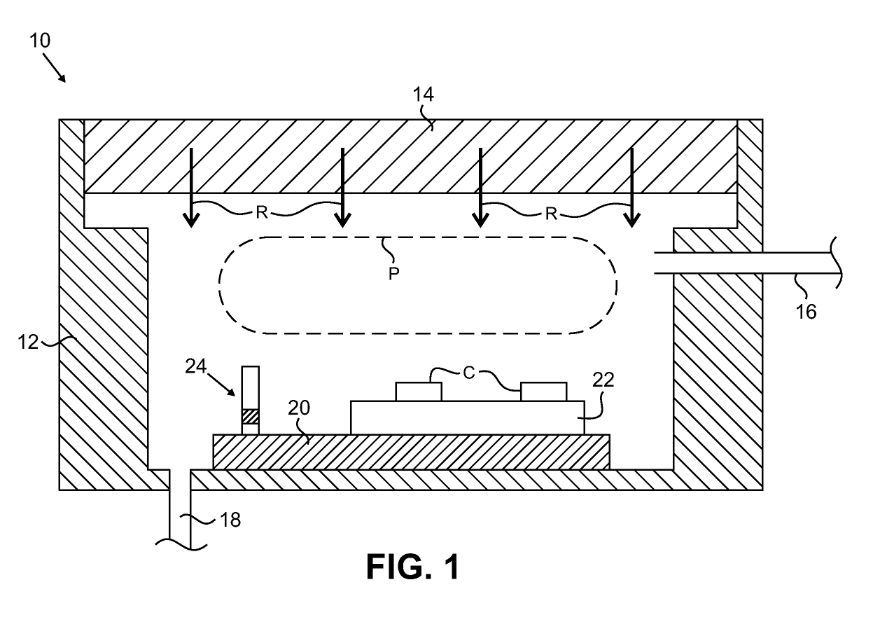

FIG. 1 illustrates one embodiment of a plasma processing apparatus 10 capable of preparing a component for bonding according to the present invention. Plasma processing apparatus 10 includes processing vessel 12, power unit 14, inlet 16 and exhaust line 18. Processing vessel 12 includes an interior configured to accommodate component (target object) C, such as a fan inlet shroud fairing, and to process component C with a plasma. Power unit 14 supplies electromagnetic radiation R into processing vessel 12 and generates plasma P by the application of electromagnetic radiation R to a gas or silane in processing vessel 12. Inlet 16 allows gases, vapors and silanes to enter processing vessel 12. When electromagnetic radiation R is applied to the introduced gases or silanes, plasmas are formed. Exhaust line 18 allows for vacuum evacuation of processing vessel 12. Plasma processing apparatus 10 optionally includes shelf 20, component support 22 and silane deposition monitoring system 24. Component support 22 and silane deposition monitoring system 24 are described in further detail in U.S. patent application Ser. No. 12/255,203, filed on Oct. 21, 2008 and U.S. patent application Ser. No. 12/255,177, filed on Oct. 21, 2008, respectively. The operation of plasma processing apparatuses to generate plasmas are known in the art. However, the present invention provides for plasma silanization of component C while extending the stability and shelf life of the resulting silanized component prior to bonding.

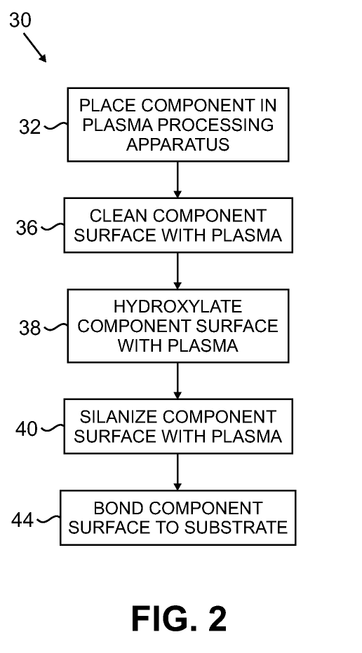

FIG. 2 illustrates one embodiment of component bonding preparation method 30. Component bonding preparation method 30 includes placing component C in plasma processing apparatus 10 (step 32), cleaning a surface of component C with a plasma (step 36), hydroxylating the surface of component C with a plasma (step 38), silanizing the surface of component C with a plasma (step 40) and bonding the plasma silanized surface of component C to a substrate (step 44). Steps 36, 38 and 40 are all capable of being performed within processing vessel 12 of plasma processing apparatus 10.

Component bonding preparation method 30 will work on surfaces made of various materials. Generally, any surface with organic functional groups can be prepared according to component bonding preparation method 30. Component C surfaces capable of bonding preparation include polymers, metals and organic matrix composites. Suitable polymers include polyamides, polyimides, thermoset materials and combinations thereof. Suitable metals include titanium, beryllium, magnesium, magnesium alloys and combinations thereof. Additionally, a metal having alkaline functional groups at its surface is also suitable. “Organic matrix composites” refers to composite materials having one or more functional groups containing carbon atoms. Suitable organic matrix composites include carbon composites, thermoplastic composites and fiber-reinforced plastics.

Beginning with step 32, component C is placed inside processing vessel 12 of plasma processing apparatus 10. Component C is typically placed within processing vessel 12 on shelf 20 or component support 22. Plasmas are used during cleaning step 36, hydroxylating step 38 and silanizing step 40. During these steps, plasma will interact with all exposed surfaces of component C.

In step 36, the surface of component C is cleaned using a plasma. Cleaning the component surface refers to removing contaminants and weak boundary layers from the surface of component C. For components having a surface sufficiently clean or already cleaned by other means, cleaning step 36 becomes optional. Cleaning step 36 includes drawing a vacuum in processing vessel 12, introducing gas into processing vessel 12, applying electromagnetic radiation within processing vessel 12 and evacuating processing vessel 12. A vacuum is drawn on processing vessel 12 via exhaust line 18, which is connected to a vacuum pump (not shown) configured to create a vacuum in processing vessel 12. Once the vacuum is applied, gas is introduced into processing vessel 12 via inlet 16. Suitable gases for cleaning step 36 include argon, oxygen, tetrafluoromethane, hydrogen and combinations thereof. Once the gas is introduced and the pressure within processing vessel 12 stabilizes, power unit 14 delivers electromagnetic radiation R to the interior of processing vessel 12. The application of electromagnetic radiation R to the gas introduced into processing vessel 12 results in excitation of the gas into a plasma state (plasma P). Power unit 14 delivers electromagnetic radiation R to processing vessel 12 to maintain plasma P for a predetermined time. During this time plasma P removes contaminants and weak boundary layers from the surface of component C. Once the predetermined time for electromagnetic radiation R delivery has expired, processing gas present in processing vessel 12 is evacuated via exhaust line 18.

In step 38, the surface of component C is hydroxylated. Hydroxylation refers to the addition of hydroxyl groups (—OH) onto the surface of component C. Hydroxylating step 38 includes introducing a hydroxylating agent (gas or vapor) into processing vessel 12, applying electromagnetic radiation within processing vessel 12 and evacuating processing vessel 12. During hydroxylating step 38, processing vessel 12 remains under vacuum conditions. As with cleaning step 36, the hydroxylating agent is introduced into processing vessel 12 via inlet 16 during hydroxylating step 38. Suitable hydroxylating agents for hydroxylating step 38 include water vapor, hydrogen peroxide, methanol and combinations thereof. When hydrogen peroxide or methanol are used in hydroxylating step 38 they are introduced to processing vessel 12 as vapors. Once the hydroxylating agent is introduced and pressure within processing vessel 12 stabilizes, power unit 14 delivers electromagnetic radiation R to the interior of processing vessel 12. The application of electromagnetic radiation R to the hydroxylating agent introduced into processing vessel 12 results in excitation of the hydroxylating agent into a plasma state (plasma P). Power unit 14 delivers electromagnetic radiation R to processing vessel 12 to maintain plasma P for a predetermined time. During this time plasma P introduces hydroxyl groups onto the surface of component C. Once the predetermined time for electromagnetic radiation R delivery has expired, processing gas or vapor present in processing vessel 12 is evacuated via exhaust line 18.

In step 40, the surface of component C is silanized using a plasma. Silanization refers to the addition of a silane layer through self-assembly to the surface of component C. Silanes are a class of chemical compounds containing silicon and hydrogen. Silanes are commonly used to enhance adhesion between organic resins and inorganic substrates. Silanes generally improve the strength and integrity of a bond between components. A silane is often applied to bonding surfaces of aircraft components, such as fan inlet shroud fairings, prior to bonding the component to a frame or other component.

Different types of silanes are used to improve the bonding properties of components, whether they are for aircraft or other commercial uses. The general formula of silanes used to enhance bonding is RₙSiX₍₄₋ₙ₎. These silanes typically contain a hydrolysable group (X), such as chlorine (Cl), a methoxy group (—OCH₃) or an ethoxy group (—OCH₂CH₃), and a non-hydrolysable group (R). The non-hydrolysable group (R) is designed to provide reactive surfaces to the adhesive. The type of silane chosen for bonding preparation depends on the adhesive used for bonding. For example, vinyl silanes are typically chosen when the bonding adhesive is a silicone because vinyl silanes are compatible with the chemistry of the silicone adhesive. Suitable vinyl silanes include vinyltrimethylsilane, vinyltrimethylethoxysilane, vinyldimethylethoxysilane and vinyltrimethoxypropylsilane. Similarly, amino silanes are typically chosen when the bonding adhesive is bismaleimide because the amino silanes are chemically compatible with bismaleimide. Suitable amino silanes include 3-aminopropylethoxy silane, 3-aminopropyltriethoxysiland and 3-aminopropyltrimethoxysilane. Other silanes can also be used for different adhesives such as epoxies and urethanes.

Silanizing step 40 includes introducing a silane or silane mixture into processing vessel 12, applying electromagnetic radiation within processing vessel 12 and evacuating processing vessel 12. During silanizing step 40, processing vessel 12 remains under vacuum conditions. A silane or silane mixture is introduced into processing vessel 12 via inlet 16 during silanizing step 40. Suitable silanes for silanizing step 40 include amino silanes and vinyl silanes, as described above, and other silanes depending upon the adhesive that will be used for bonding component C to a substrate following silanization. Once the silane or silane mixture is introduced and pressure within processing vessel 12 stabilizes, power unit 14 delivers electromagnetic radiation R to the interior of processing vessel 12. The application of electromagnetic radiation R to the silane or silane mixture introduced into processing vessel 12 results in excitation of the silane or silane mixture into a plasma state (plasma P). Power unit 14 delivers electromagnetic radiation R to processing vessel 12 to maintain plasma P for a predetermined time, during which plasma P deposits a layer of silane molecules onto the surface of component C. Once the predetermined time for electromagnetic radiation R delivery has expired, residual silane present in processing vessel 12 is evacuated via exhaust line 18.

Silane deposition or grafting in silanizing step 40 is promoted by the presence of the hydroxyl groups on the surface of component C. Following completion of hydroxylating step 38, the surface of component C contains hydroxyl groups. These hydroxyl groups attack and displace the hydrolysable group (X) of the silane plasma to form covalent silicon-oxygen (—Si—O—Si—) bonds on the surface of component C. Silicon-oxygen bonds are sufficiently stable for molecules of the silane to self-assemble into a layer on the surface of component C. Following silanization, a layer of silane is attached to the exposed surfaces of component C. The silane layer is arranged such that the covalent silicon-oxygen bonds are proximal with the surface of component C and the non-hydrolysable groups are distal to the surface of component C and free to interact with adhesive later-applied during bonding step 44.

The amount of electromagnetic radiation (power density) applied to processing vessel 12 during silanizing step 40 is significantly lower than the amount applied in cleaning step 36 and hydroxylating step 38. The power density applied during silanizing step 40 is typically about ten percent to about thirty percent of the power density applied during cleaning step 36 and hydroxylating step 38. In exemplary embodiments, the power density applied during silanizing step 40 is between about fifteen percent and twenty-five percent of the power density applied during cleaning step 36 and hydroxylating step 38. Under the influence of plasma, covalent bonds (including silicon-oxygen bonds) are subject to fragmentation. Particularly active groups, vinyl groups, for example, are especially vulnerable to fragmentation. The combination of hydroxylating step 38 and the reduced power density applied during silanizing step 40 allows the silane to covalently bond with the surface of component C without destroying the other functionalities of the silane (e.g., the non-hydrolysable groups). The power density applied to processing vessel 12 during plasma silanizing step 40 is just sufficient to promote hydrolysis of the silane to the hydroxylated surface of component C while preventing or reducing undesired fragmentation. The presence of the hydroxyl groups on the surfaces of component C provides a preferred reaction path for silane hydrolysis and creates a generally ordered and unfragmented layer of silane molecules covalently bonded to the surface of component C.

Plasma silanizing step 40 can be performed with any reactive silane having hydrolysable groups such as, but not limited to, methoxy, dimethoxy, trimethoxy, ethoxy, diethoxy, triethoxy, chloro-, dichloro- and trichloro-groups. The non-hydrolysable groups of the silane include, but are not limited to, vinyl, amine, alcohol, glycidyl, thio, butenyl, allyl, alkyl and perfluoroalkyl. The thickness of the generally ordered and unfragmented silane layer incorporated on the surfaces of component C will vary depending on the non-hydrolysable group(s) of the silane used in plasma silanizing step 40. However, most silane layers prepared according to the present invention will typically have a thickness less than about 100 nm.

Following silanizing step 40, plasma silanized component C is removed from processing vessel 12 and plasma processing apparatus 10. Silanized component C is then stored until needed for bonding. In an exemplary embodiment, plasma silanized component C is stable for about thirty days. Thirty days after the completion of plasma silanizing step 40, the silane layer incorporated onto the exposed surfaces of component C remains suitable for enhancing the bonding of component C to a substrate. In step 44, the surface of component C is bonded to a substrate. An adhesive is applied to either the substrate or the surface of component C and the substrate and the surface are positioned together as desired for bonding.

TABLE 1

| Silane Layer | Relative Bond | |
|---|---|---|
| Age (Day) | Shear Strength (%) | % RSD |
| 1 | 100 | 8 |
| 2 | 94 | 11 |
| 3 | 95 | 4 |
| 7 | 94 | 15 |
| 9 | 94 | 5 |
| 15 | 95 | 6 |
| 22 | 104 | 7 |
| 30 | 106 | 5 |

Table 1 indicates the relative shear strengths of bonds prepared on silane layers of different age. The shear strength of a bond prepared on Day 1 was used as a baseline value (100%) for comparison with the shear strengths of bonds prepared on aged silane layers. Table 1 indicates that the shear strengths of bonds prepared on silane layers aged up to about thirty days are nearly equivalent or exceed the shear strength of a bond prepared on Day 1. Thus, after about thirty days, the silane layer formed in plasma silanizing step 40 remains suitable for facilitating strong component bonding.

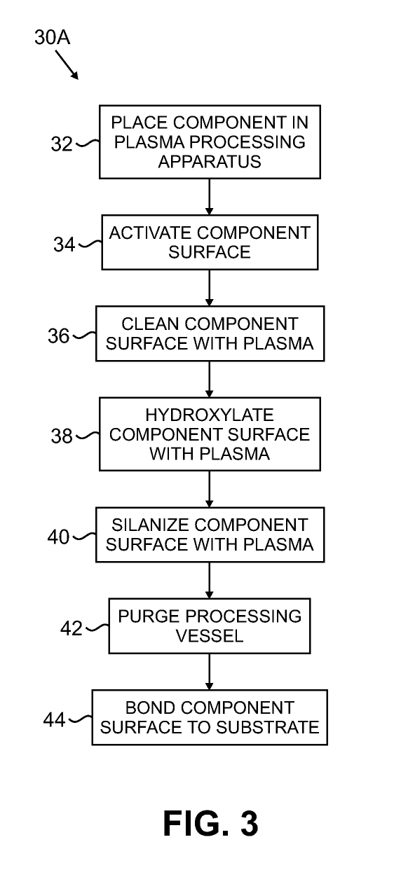

FIG. 3 illustrates component bonding preparation method 30A. Component bonding preparation method 30A is component bonding preparation method 30 of FIG. 2 with added optional steps. Component bonding preparation method 30A also includes activating the component surface (step 34) and purging processing vessel 12 (step 42).

In step 34, the surface of component C is activated with oxygen. Activation refers to the addition of oxygen radicals to the surface of component C. Oxygen radicals are added to the surface of component C to make the surface more reactive. Activation step 34 follows the same process as cleaning step 32. However, in activation step 34, suitable gases include oxygen alone or mixtures of oxygen and argon or tetrafluoromethane. When oxygen or mixtures including oxygen are used in cleaning step 32, the addition of oxygen radicals to the surface of component C may occur contemporaneously with the removal of contaminants and weak boundary layers.

In step 42, processing vessel 12 is purged of plasma by-products prior to the removal of component C. A high flow rate of gas is introduced into processing vessel 12 and maintained without the addition of electromagnetic radiation. Argon is a suitable gas for purging processing vessel 12. Following the purge, processing vessel 12 is vented to the atmosphere and component C is removed from plasma processing apparatus 10.

### Example

An example of one embodiment of the method of the present invention is described herein. Composite plaques were prepared for bonding using a plasma processing apparatus. The plasma processing apparatus included a processing vessel having a volume of approximately 1900 liters.

Cleaning. The composite plaques were placed inside the processing vessel. A vacuum was drawn on the processing vessel to generate a base pressure of 30 millitorr (mT). Once the base pressure was reached, oxygen was introduced into the processing vessel at a flow rate of 1750 standard cubic centimeters per minute (sccm), providing a processing vessel pressure of 135 mT. The pressure inside the processing vessel was allowed to stabilize for approximately ten seconds. After stabilization, 2000 watts (W) of 13.56 MHz radio frequency (RF) power was applied providing a power density of approximately 0.10 W/cm² to excite the oxygen into a plasma state. The plasma was maintained for five minutes. After five minutes, oxygen in the processing vessel was evacuated and the processing vessel was allowed to stabilize at the base pressure of 30 mT.

Hydroxylation. Argon was introduced into the processing vessel at a rate of 150 sccm. Ten seconds after the introduction of the argon, methanol (as methanol vapor) was added to the processing vessel at a rate of 45 mL/hr. The pressure inside the processing vessel was allowed to stabilize for approximately ten seconds. After stabilization, 3000 W of RF power was applied to excite the gas and vapor into a plasma state. The plasma was maintained for two minutes. The gas and vapor in the processing vessel was then evacuated and the processing vessel was allowed to stabilize at the base pressure of 30 mT.

Silanization. Argon was introduced to the processing vessel at a rate of 150 sccm. After pressure stabilization, vinyltrimethoxypropylsilane (VTMS) was introduced to the processing vessel at a rate of 45 mL/hr. After stabilization, 500 W of RF power was applied to the process gas mixture to establish a plasma. The plasma was maintained for two minutes. The argon and silane in the processing vessel was then evacuated and the processing vessel was allowed to stabilize at the base pressure of 30 mT.

Vessel purge. The processing vessel was purged of residual plasma by-products. A high flow rate of argon (1000 sccm) was introduced to the processing vessel and maintained without RF power for two minutes. The processing vessel was then vented to the atmosphere and the composite plaques were removed.

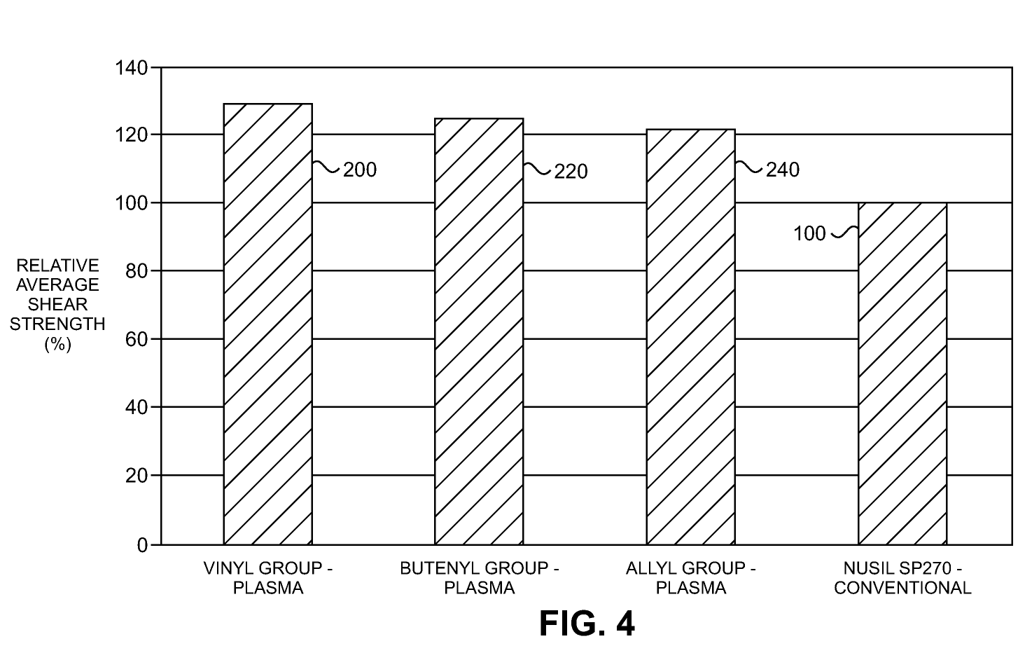

FIG. 4 is a bar graph illustrating relative bond strengths of bonds made according to the present invention compared to a conventionally prepared bond that does not use a plasma silanized surface. Bar 100 on the far right indicates the average shear strength of a conventional bond preparation using SP-270, a silicone primer available from NuSil Technology (Carpinteria, Calif.). The average shear strength of the conventional bond is used as a baseline (100%) for comparison with the average shear strengths of bonds prepared according to the present invention. Bar 200 on the far left indicates the relative average shear strength of a bond prepared following vinyl silanization using a plasma (described in the Example above). The average shear strength of a bond prepared using plasma silanization with a vinyl silane (bar 200) is about 30% greater than the average shear strength of a bond prepared using the conventional (non-plasma) process (bar 100). Bars 220 and 240 indicate the relative average shear strengths of bonds prepared using butenyl and allyl plasma silanes, respectively. The average shear strengths of bonds prepared using plasma silanization with butenyl and allyl silanes (bars 220 and 240, respectively) are more than 20% greater than the average shear strength of a bond prepared using the conventional process (bar 100).

In summary, the present invention provides methods for component bonding preparation. The methods allow for the preparation of a component for bonding (cleaning and silanization) within a plasma processing apparatus. Methods of the present invention reduce the time required for preparation of the component prior to bonding when compared to other methods. The methods also allow for the preparation of components having geometries that present challenges for conventional cleaning and silane application. Additionally, the methods provide for extended stability and shelf life for silanized components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims

1. A method comprising:
placing a component comprising a surface within a processing vessel;
hydroxylating the component surface with a plasma comprising:
introducing a hydroxylating agent into the processing vessel; and
applying electromagnetic radiation to excite the hydroxylating agent into a first plasma, which adds hydroxyl groups to the component surface; and
silanizing the component surface with a plasma comprising:
introducing a silane into the processing vessel; and
applying electromagnetic radiation to excite the silane into a second plasma so that the hydroxyl groups added to the component surface hydrolyze the second plasma to bond a silane layer to the component surface.

2. The method of claim 1, wherein the hydroxylating agent is selected from the group consisting of water, hydrogen peroxide, methanol and combinations thereof.

3. The method of claim 1, wherein the silane has a hydrolysable group and a non-hydrolysable group.

4. The method of claim 3, wherein the hydrolysable group is selected from the group consisting of methoxy, dimethoxy, trimethoxy, ethoxy, diethoxy, triethoxy, chloro-, dichloro-, trichloro- and combinations thereof.

5. The method of claim 3, wherein the non-hydrolysable group is selected from the group consisting of vinyl, amine, alcohol, glycidyl, thio, butenyl, allyl, alkyl, perfluoroalkyl, and combinations thereof.

6. The method of claim 1, wherein the silane layer is stable for at least about thirty days.

7. The method of claim 1, wherein power of the electromagnetic radiation applied to excite the silane is about ten percent to about thirty percent of power of the electromagnetic radiation applied to excite the hydroxylating agent.

8. The method of claim 7, wherein the power of the electromagnetic radiation applied to excite the silane is about fifteen percent to about twenty-five percent of power of the electromagnetic radiation applied to excite the hydroxylating agent.

9. The method of claim 1, wherein the component surface comprises a polymer.

10. The method of claim 9, wherein the polymer is selected from the group consisting of polyamides, polyimides, thermoset materials and combinations thereof.

11. The method of claim 1, wherein the component surface comprises an organic matrix composite.

12. The method of claim 1, wherein the component surface comprises a metal.

13. The method of claim 12, wherein the metal is selected from the group consisting of titanium, beryllium, magnesium, magnesium alloys and combinations thereof.

14. The method of claim 12, wherein the component surface comprises a metal with alkaline surface groups.

15. The method of claim 1, wherein the silane layer has a thickness less than about 100 nm.

16. The method of claim 1, further comprising:
cleaning the component surface with a plasma comprising:
introducing a cleaning agent into the processing vessel; and
applying electromagnetic radiation to excite the cleaning agent into a third plasma that removes contaminants and weak boundary layers from the component surface.

17. The method of claim 16, wherein the cleaning agent is selected from the group consisting of argon, oxygen, tetrafluoromethane, hydrogen and combinations thereof.

18. The method of claim 1, further comprising bonding the component surface to a substrate with an adhesive.

19. A component preparation method comprising:
cleaning a component surface;
plasma hydroxylating the component surface; and
plasma silanizing the component surface.

20. The method of claim 19, further comprising:
bonding the component surface to a substrate.

21. The method of claim 19, wherein cleaning the component surface comprises plasma cleaning.

22. The method of claim 19, wherein electromagnetic radiation power applied to plasma silanize the component surface is about ten percent to about thirty percent of electromagnetic radiation power applied to plasma hydroxylate the component surface.

23. The method of claim 21, wherein electromagnetic radiation power applied to plasma silanize the component surface is about fifteen percent to about twenty-five percent of electromagnetic radiation power applied to plasma hydroxylate the component surface.

24. The method of claim 19, wherein plasma silanizing the component surface provides a silane layer having a thickness less than about 100 nm on the component surface.
